(19) United States
(12) Patent Application Publication
(10) Pub. No.: US 2014/0185839 A1
(43) Pub. Date: Jul. 3, 2014

(54) SUSPENSION STRUCTURE OF MULTI-FUNCTIONAL TYPE VIBRATION ACTUATOR

(71) Applicant: NAMIKI SEIMITSU HOUSEKI KABUSHIKI KAISHA, Tokyo (JP)

(72) Inventors: Yuichi HASHIMOTO, Tokyo (JP); Minoru UEDA, Tokyo (JP); Takayuki KUMAGAI, Tokyo (JP); Yosuke HASHIMOTO, Tokyo (JP)

(73) Assignee: NAMIKI SEIMITSU HOUSEKI KABUSHIKI KAISHA, Tokyo (JP)

(21) Appl. No.: 14/093,299

(22) Filed: Nov. 29, 2013

(30) Foreign Application Priority Data
Dec. 27, 2012 (JP) 2012-283779

(51) Int. Cl. H04R 1/00

(52) U.S. Cl. CPC H04R 1/00
USPC 381/162

(57) ABSTRACT

Provided is a multi-functional type vibration actuator capable of stabilizing a vibration characteristic and improving variation in a resonance frequency by matching vibration waveforms when increasing/reducing an input signal frequency, by using a frame-shaped suspension of a polygonal shape. A spring characteristic of the frame-shaped suspension may be improved by forming J-shaped structures which is formed by connecting an extension portion and an arc, on all corner portions of the frame-shaped suspension of the polygonal shape, whereby reducing variation in a vibration waveform and a resonance frequency when sensible vibration is generated.

### CROSS-REFERENCE TO RELATED PATENT APPLICATIONS

This application claims the benefit of Japanese Patent Application No. 2012-283779, filed on Dec. 27, 2012, in the Japan Patent Office, the disclosure of which is incorporated herein in its entirety by reference.

### BACKGROUND OF THE INVENTION

1. Field of the Invention

The present invention relates to a multi-functional type vibration actuator having a dynamic structure, in which a sound reproduction unit is configured by attaching a diaphragm including a voice coil to a housing and a magnetic circuit unit having a magnet and a yoke is supported in the housing by using a frame-shaped suspension so as to dispose the voice coil in a magnetic gap formed by the magnetic circuit unit.

2. Description of the Related Art

Recently, a mobile communication device represented by a mobile phone has a vibration generation function notifying a user of a receiving call by using sensible vibrations, in addition to a sound reproduction function notifying the user of a receiving call. A multi-functional type vibration actuator disclosed in Japanese Patent No. 4520547 (Patent Document 1) is used as a component enabling the above two functions by using a single device. The multi-functional type vibration actuator disclosed in the Patent Document 1 has a structure in which a magnetic circuit unit having a circular plane shape is mounted in a polygonal-shaped housing, and may maintain a stabilized vibration characteristic in a case body of a mobile communication device and improve a space efficiency when being mounted in a case body of a mobile phone, etc.

Japanese Patent No. 5007413 (Patent Document 2) discloses a multi-functional type vibration actuator, in which a polygonal shaped magnetic circuit unit having a magnet is supported by an inner wall of a housing via a frame-shaped suspension having a two-fold rotational symmetric shape. As such, opposite corners make a pair for absorbing distortion, and a volume of the magnetic circuit unit may be increased by forming them in a polygonal shape, including the magnetic circuit unit, and behavior of the magnetic circuit unit may be stabilized.

However, even with the above-described advantages, the multi-functional type vibration actuator disclosed in the Patent Document 1 has a limited volume of the magnetic circuit unit due to a structure thereof, when compared with the multi-functional type vibration actuator disclosed in the Patent Document 2. That is, although the vibration characteristic may be stabilized by using a suspension having arms arranged in a radial direction, the multi-functional type vibration actuator disclosed in the Patent Document 1 has inferior property to the multi-functional type vibration actuator disclosed in the Patent Document 2 in view of a vibration amount when sensible vibration is generated. Also, although the multi-functional type vibration actuator disclosed in the Patent Document 2 is capable of stabilizing the behavior of the magnetic circuit unit, there is a problem that a resonance frequency varies depending on an input level of a driving signal due to a spring characteristic of a frame-shaped suspension which will be described later. Moreover, for the same reason, vibration waveforms output from the magnetic circuit unit are different from each other in a case when the frequency of the input signal is increased and in a case when the frequency of the input signal is reduced.

(Patent Document 1) Japanese Patent No. 4520547

(Patent Document 2) Japanese Patent No. 5007413

### SUMMARY OF THE INVENTION

The present invention provides a multi-functional type vibration actuator which has a frame-shaped suspension, is capable of stabilizing a vibration characteristic and is capable of preventing a resonance frequency from varying by matching vibration wave forms when an input signal frequency is increased and reduced.

According to an aspect of the present invention, there is provided a multi-functional type vibration actuator, in which a magnetic circuit unit is supported by a frame-shaped suspension having a polygonal plane shape, is characterized in that J-shaped structures are formed on corner portions of the frame-shaped suspension. In more detail, in a plane of the frame-shaped suspension having the polygonal shape and supporting the magnetic circuit unit, all the corner portions are formed by the protruded J-shaped structures, each of which is formed by connecting via an arc an extension portion and an arm portion connected from a fixing portion, the extension portion being elongated from the fixing portion and the arm portion. Also, the extension portion includes a part that is disposed in parallel with the arm portion connected thereto, in a planar shape.

According to another aspect of the present invention, the frame-shaped suspension described above is characterized in that the corner portions having the J-shaped structures are bent. In more detail, the J-shaped corner portions are bent except for the extension portions of linear type.

According to another aspect of the present invention, the frame-shaped suspension is characterized in that arm portions of the frame-shaped suspension are bent.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view of a multi-functional type vibration actuator according to an embodiment of the present invention;

FIG. 2 is an exploded perspective view of the multi-functional type vibration actuator according to the embodiment of the present invention;

FIG. 3 is side sectional views of the multi-functional type vibration actuator taken along line A-A′ and line B-B′ of FIG. 1;

FIG. 4 is a perspective view of a driving unit according to an embodiment of the present invention;

FIG. 5 is a plan view of frame-shaped suspensions according to the embodiment of the present invention and according to the conventional art; and

FIG. 6 is perspective view showing modified examples of the frame-shaped suspension according to the embodiment of the present invention.

FIG. 7 is a graphical illustration of the vibration characteristics F1, F2 and F3

FIG. 8 is a graphical illustration of the vibration characteristics F4 and F5

### DETAILED DESCRIPTION OF THE INVENTION

### Mode For Carrying Out the Invention

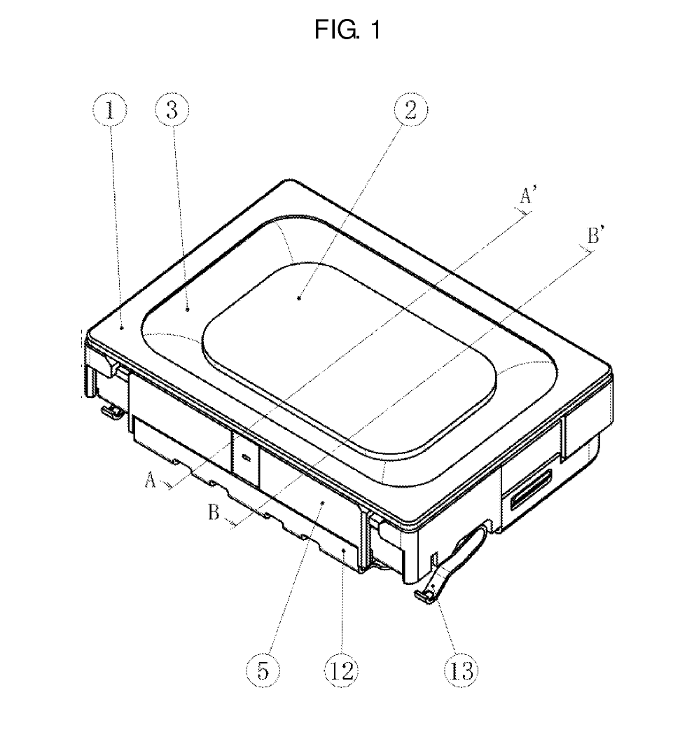

Hereinafter, embodiments of the present invention will be described with reference to FIGS. 1 through 6. Also, like reference numerals are used for the same components.

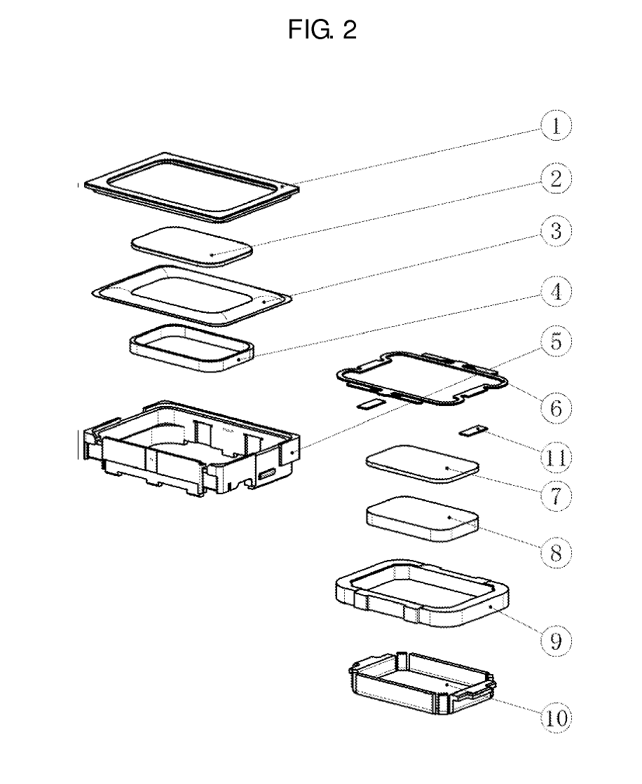

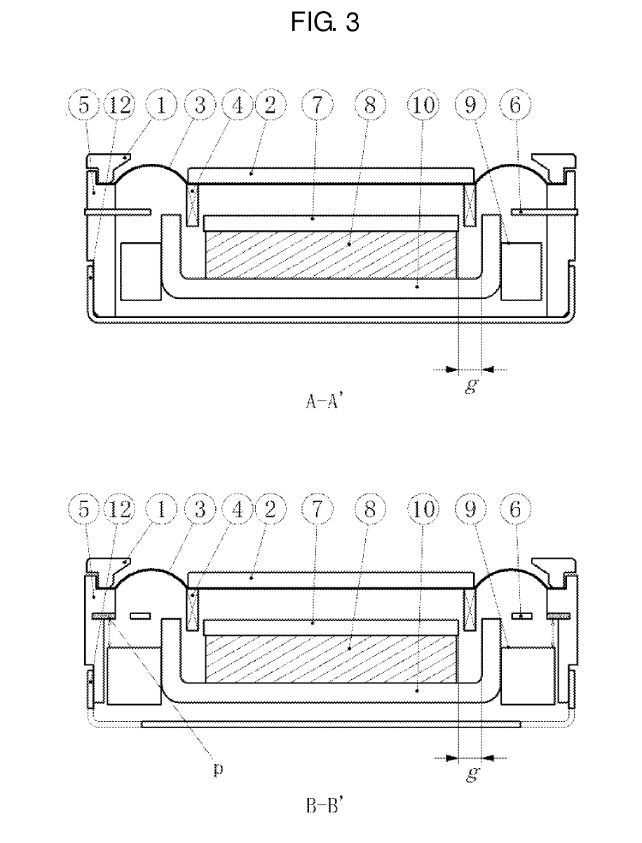

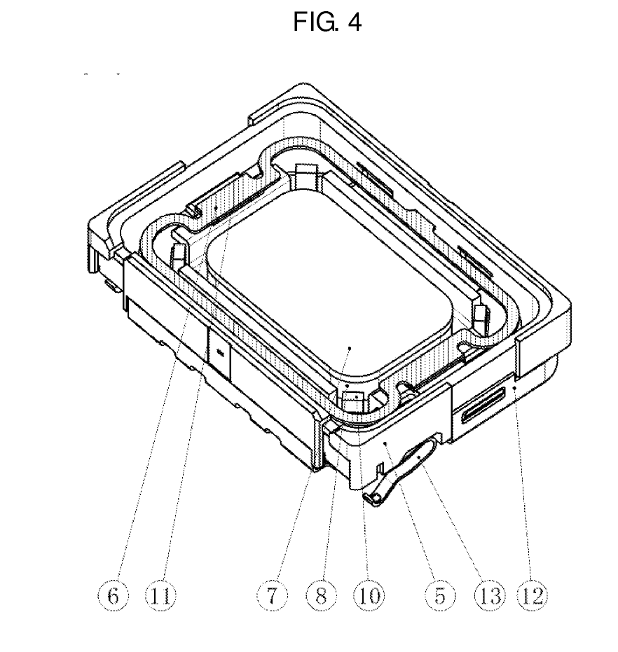

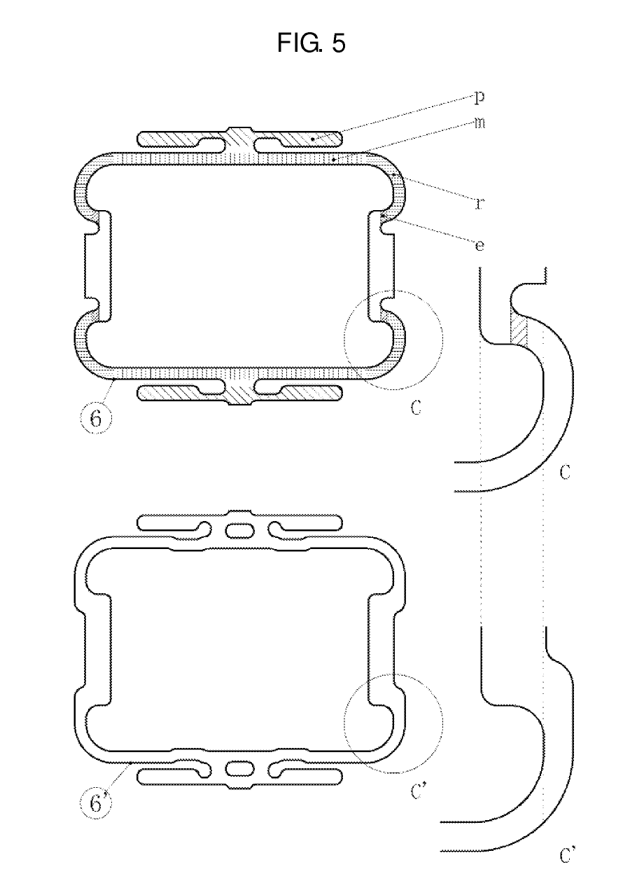

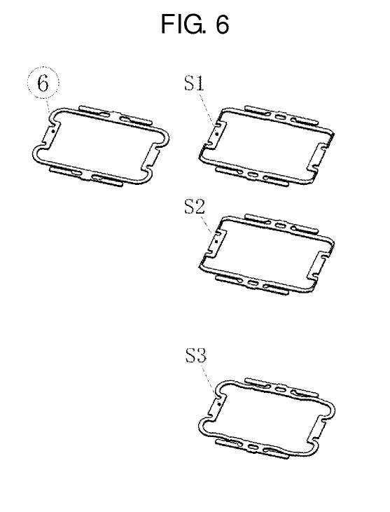

FIG. 1 is a perspective view of a whole multi-functional type vibration actuator according to an embodiment of the present invention, FIG. 2 is an exploded perspective view, FIG. 3 shows side sectional views of the multi-functional type vibration actuator taken along line A-A′ and line B-B′ of FIG. 1, FIG. 4 is a perspective view of a driving unit according to an embodiment of the present invention, FIG. 5 shows plan views of frame-shaped suspensions according to the embodiment of the present invention and according to the conventional art, and FIG. 6 shows perspective views of modified examples of the frame-shaped suspension according to the embodiment of the present invention.

As shown in FIGS. 1, 2, and 3, the multi-functional type vibration actuator according to the embodiment of the present invention has a structure, in which a sound reproduction unit including a center cap 2, a diaphragm 3, and a voice coil 4 is fixed on an upper portion of a housing 5, a magnetic circuit unit including a pole piece 7, a magnet 8, a yoke 10, and a weight 9 is supported by an inner wall of the housing 5 via a frame-shaped suspension 6 and an elastic member 11, and a grill 1 is attached to an upper portion of the sound reproduction unit and a cover 12 and a contact terminal 13 are respectively attached to a lower portion of the housing 5. According to the above structure, the multi-functional type vibration actuator includes the frame-shaped suspension 6 that is a polygonal shape, as well as the housing 5, the sound reproduction unit, and the magnetic circuit unit of polygonal shapes. As such, a volume of the magnetic circuit unit may be increased by forming them, including the magnetic circuit unit, in the polygonal shape, while improving a space efficiency when the multi-functional type vibration actuator is mounted in a case body such as a mobile phone.

Also, as shown in FIGS. 2 and 3, the multi-functional type vibration actuator according to the present embodiment has a dynamic structure in which the magnetic circuit unit is supported by the inner wall of the housing via the frame-shaped suspension 6 and the elastic member 11 and the voice coil 4 of the sound reproduction unit is disposed in a magnetic gap g where a magnetic flux generated by the magnet 8 is concentrated by inserting the magnet 8 between the pole piece 7 and the yoke 10 formed as magnetic bodies in the magnetic circuit unit. Thus, when a frequency of an input signal to the voice coil 4 is set to be adjacent to a resonance frequency of the sound reproduction unit, the sound reproduction unit vibrates, and when the frequency of the input signal to the voice coil 4 is set to be adjacent to a resonance frequency of the magnetic circuit unit, the magnetic circuit unit vibrates. That is, sound reproduction performed by the vibration of the sound reproduction unit and sensible vibration generation performed by the vibration of the magnetic circuit unit may be controlled by adjusting the frequency of the input signal. Also, since the resonance frequency is used, the input signals for reproducing the sound and generating the sensible vibration may be combined to a single signal so that the above two functions may be performed simultaneously. Moreover, since the voice coil 4 is provided in the magnetic gap g, on which the magnetic flux is concentrated, to improve a magnetic efficiency, the sound and the sensible vibration may be generated with a small loss.

In addition to the above effects caused by the basic structure of the present invention, specific technical features and effects obtained according to the present invention will be described with reference to FIGS. 4 and 5. FIG. 4 is perspective view showing a driving unit without the sound reproduction unit, and FIG. 5 is a diagram for comparing the frame-shaped suspension 6 according to the present embodiment with a frame-shaped suspension 6′ according to the conventional art. As shown in FIGS. 4 and 5, all corner portions of the frame-shaped suspension 6 of the present embodiment have J-shaped structures, each including an extension portion e that is elongated in same direction as arm portions m.

By using the above-described structure, the multi-functional type vibration actuator according to the present embodiment gives symmetry to the vibration characteristic caused by the conventional frame-shaped suspension, and may reduce a variation in the resonance frequency caused by the input signal level. The above effects may be obtained by forming the extension portions so as to have the J-shaped structure on each of the corner portions. That is, a distortion amount that may be absorbed by the corner portions of the frame-shaped suspension 6 may be increased by the J-shaped structures on the corners, and a spring characteristic of the entire frame-shaped suspension 6 may be similar to that of a linear spring, thereby obtaining the symmetric spring characteristic like a general linear spring. As such, the multi-functional type vibration actuator may easily set the frequency of the driving signal that is necessary for generating the sensible vibration, without degrading the above effects obtained by the basic structure of the multi-functional type vibration actuator.

Also, by the above spring characteristic, the variation in the resonance frequency and a maximum amplitude, which is caused depending on the direction of the increase/reduction of the input signal frequency when the driving signal is input in case of the structure using the conventional frame-shaped suspension, may be prevented. In more detail, the problem that different vibration waveforms are shown depending on the direction approaching to a target input signal frequency may be addressed, and thus, a variation in a vibration amount according to the variation of the input signal frequency may be reduced, whereby generating stabilized sensible vibration.

Also, as shown in FIG. 4, according to the present embodiment, a support structure, in which the elastic member 11 is inserted between the magnetic circuit unit and the frame-shaped suspension 6, is used. Therefore, in addition to the effects obtained due to the frame-shaped suspension 6, the distortion amount absorbed by the spring characteristic of the support structure of the magnetic circuit unit may be increased, wherein the magnetic circuit unit includes the frame-shaped suspension 6 and the elastic member 11 as a set, and the symmetric vibration characteristic and effects obtained therefrom may be obtained by the support structure.

Here, FIG. 6 shows modified examples S1, S2, and S3 of the frame-shaped suspension 6 based on the same technical point of view as that of the above-described embodiment of the present invention. From among the modified examples S1, S2, and S3, S1 and S2 are characterized in that the J-shaped corners are bent. According to the above structure, the modified examples S1 and S2 of the frame-shaped suspension 6 may allow stress on the corner portions caused by the absorbed distortion amount to flow in a direction that is different from the vibration direction of the magnetic circuit unit, in addition to the increase in the distortion amount absorbed by the corner portions. Therefore, when the frame-shaped suspensions according to the modified examples are used, it may prevent the stress on the corner portions from affecting to the vibration characteristic. Also, in addition to the above-described effects of the present invention, the spring characteristic and the symmetry of the vibration characteristic may be further improved. In addition, a bending direction is different from those of adjacent corners, and thus, the frame-shaped suspension shown in the modified example has a two-fold rotational symmetric shape like the modified example S1. Therefore, the above-described effects of the present invention may be obtained while stabilizing the behavior of the magnetic circuit unit as disclosed in the Patent Document 2.

Also, unlike the modified examples S1 and S2, the modified example S3 has a structure, in which arm portions m are bent. Therefore, the distortion amount absorbed by the frame-shaped suspension may be increased by the bent arm portions m, with the J-shaped corner portions, whereby improving the spring characteristic. Also, the modified example S3 may also has the two-fold rotational symmetric shape, like the modified example S1, and increase in the absorbed distortion amount and stabilization of the behavior may be achieved by using the modified example S3.

Also, the structures shown in the above modified examples may be combined. Thus, both the corner portions and the arm portions may be bent.

As described above, the multi-functional type vibration actuator according to the present invention is capable of stabilizing the vibration characteristic by using the frame-shaped suspension, and improving the variation in the resonance frequency by matching vibration when increasing/reducing the input signal frequency.

By using the above structure, the multi-functional type vibration actuator according to the embodiment of the present invention may allow the vibration waveforms to be matched with each other when increasing and reducing the input signal frequency. In more detail, the variation in the resonance frequency caused by the input level of the driving signal may be reduced. Also, with respect to the problem that the vibration waveform of the magnetic circuit unit when the input signal frequency is increased and the vibration waveform of the magnetic circuit unit when the input signal frequency is reduced have different vibration characteristics, the effect of applying symmetry to the signal waveforms by using the same structure may address the problem.

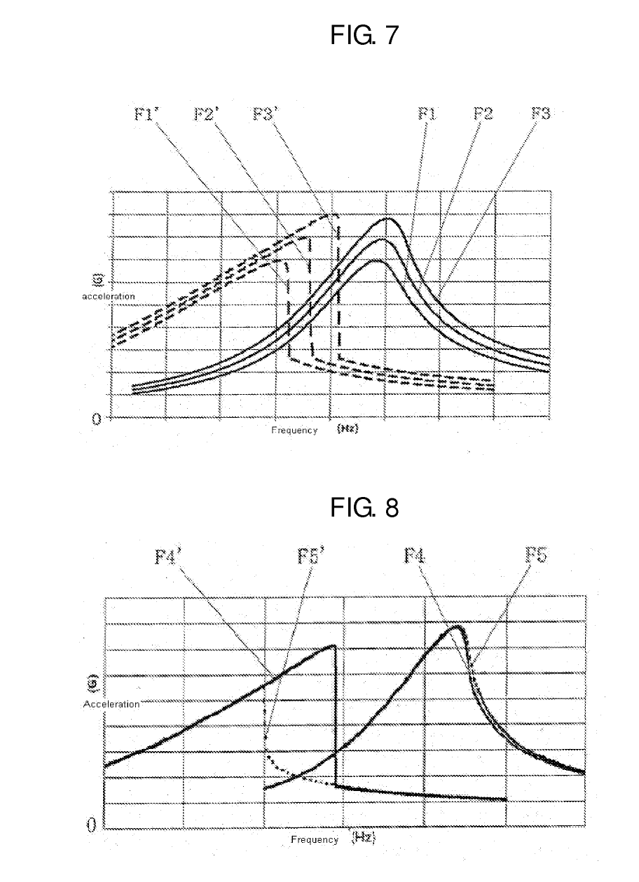

With reference to FIG. 7, a graphical representation of vibration characteristics F1, F2, and F3 according to the input signal levels in the multi-functional type vibration actuator using the frame-shaped suspension according to the present invention is shown, and vibration characteristics F1′, F2′, and F3′ according to input signal levels in the multi-functional type vibration actuator using the conventional frame-shaped suspension is shown. In addition, FIG. 8 shows vibration characteristics F4 and F5 in cases where an input signal frequency is increased and reduced in the multi-functional type vibration actuator according to the present invention, and vibration characteristics F4′ and F5′ in cases where the input signal frequency is increased and reduced in the multi-functional type vibration actuator according to the conventional art.

In general, according to the conventional frame-shaped suspension used in the multi-functional type vibration actuator, which is represented by the suspension disclosed in the cited reference 2, a relationship between the displacement and the load does not increase at a constant ratio by the shape thereof, a spring characteristic is shown, that is, the suspension becomes harder and an increase ratio of the load becomes greater when the displacement amount increases. Thus, when a vibratory force is applied to the frame-shaped suspension by inputting a driving signal to the voice coil, an amplitude response generated by an elastic force of the frame-shaped suspension does not increase by a constant ratio. That is, according to the multi-functional type vibration actuator using the conventional frame-shaped suspension, the vibration characteristic obtained by connecting accelerations with respect to respective frequencies is represented as backbone curves F1′, F2′ and F3′, vertexes of which are biased, as shown in FIG. 7.

As shown in FIG. 7, by the above structural problem, the multi-functional type vibration actuator using the conventional frame-shaped suspension has a problem that the resonance frequency that is the vertex of each waveform varies depending on increase/reduction in the input signal level that is the vibratory force. Moreover, with respect to the amplitude response, in cases where the frequency of the vibratory force is increased (F4′) and is reduced (F5′), different resonance frequencies and response values are output as shown in FIG. 8.

According to the frame-shaped suspension according to the embodiment of the present invention, the above structural problem may be addressed by improving the spring characteristic of the frame-shaped suspension by using the protruded J-shaped corner portions. That is, according to the frame-shaped suspension according to the embodiment of the present invention, the distortion amount absorbed by the corner portions of the suspension is increased and an increase ratio of the load is reduced, and thus, the spring characteristic of the frame-shaped suspension becomes similar to that of a general linear spring. Thus, the vibration characteristics F1′ F2′, F3′, F4′, and F5′ represented as the backbone curves in FIGS. 7 & 8 may be improved to the vibration characteristics F1, F2, F3, F4, and F5 having symmetric characteristics as shown in FIGS. 7 & 8. Therefore, the problem may be addressed by the structure of the embodiment of the present invention, and effects such as reduction in the variation of the resonance frequency, simplified signal input, and improvement in reliability as a circuit component may be obtained according to the symmetric vibration characteristic.

Also, according to the embodiment of the present invention, the stress generated when the distortion amount is absorbed by the suspension may flow in a direction that is different from the vibration direction of the magnetic circuit unit supported by the frame-shaped suspension. As such, affect of the distortion amount absorbed by the corner portions of the frame-shaped suspension according to the above embodiment to the vibration characteristic may be restrained, and the stress flows in the direction that is different from the vibration direction of the magnetic circuit unit, and thereby enhancing the symmetric characteristic and restraining the variation of the resonance frequency.

Also, according to the embodiment of the present invention, the distortion amount may be absorbed by the arm portions of the suspension, as well as by the corner portions of the suspension. Thus, the spring characteristic of the frame-shaped suspension may be similar to that of the linear spring, by using both the protruded J-shaped corner portions and the arm portions.

As described above, by using the structure according to the present invention, the multi-functional type vibration actuator using the frame-shaped suspension is capable of stabilizing the vibration characteristic, and improving the variation in the resonance frequency by matching vibration waveforms when increasing/reducing the input signal frequency.

What is claimed is:

1. A multi-functional type vibration actuator of a dynamic structure, the multi-functional type vibration actuator comprises a sound reproduction unit which includes a diagram in which a voice coil is provided, and a magnetic circuit unit which includes a magnet and is supported by a frame-shaped suspension having a polygonal shape, in a housing, a sound reproduction and a sensible vibration generation being performed by using a mutual magnetic force applied between the sound reproduction unit and the magnetic circuit unit,
wherein all corner portions of the frame-shaped suspension are formed to have J-shaped structures, each of the J-shaped structures including an extension portion elongated from a fixing portion formed on the magnetic circuit unit or the housing and an arc connected to the extension portion.

2. The multi-functional type vibration actuator of claim 1, wherein the corner portions are bent.

3. The multi-functional type vibration actuator of claim 1, wherein arm portions of the frame-shaped suspension are bent.
